(19) United States
(12) Patent Application Publication
(10) Pub. No.: US 2010/0209900 A1
(43) Pub. Date: Aug. 19, 2010

(54) ELECTRONIC AUDIO PLAYING APPARATUS WITH AN INTERACTIVE FUNCTION AND METHOD THEREOF

(75) Inventors: CHUAN-HONG WANG, Tu-Cheng (TW); LI-ZHANG HUANG, Tu-Cheng (TW); HSIAO-CHUNG CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/436,759

(22) Filed: May 6, 2009

(30) Foreign Application Priority Data
Feb. 17, 2009 (CN) 200910300446.5

(51) Int. Cl. G09B 5/04

(52) U.S. Cl. 434/321

(57) ABSTRACT

An electronic audio playing apparatus with an interactive function is provided. An interactive file stored in a data storage of the electronic audio playing apparatus includes time and sequence data, a main audio, and at least one question audio. The time and sequence data is for controlling the playing time and sequence data of the main audio and the question audios. After each question audio is played, the electronic audio playing apparatus receives answers from the user, determines whether the answers from the user is correct, and outputs a feedback audio according to the determined result.

### BACKGROUND

1. Related Applications

This application is related to a co-pending U.S. patent application filed concurrently herewith and entitled “ELECTRONIC AUDIO PLAYING APPARATUS WITH AN INTERACTIVE FUNCTION AND METHOD THEREOF”, which is incorporated herein in its entirety by reference.

2. Technical Field

The present disclosure relates to an electronic audio playing apparatus with an interactive function and a method thereof.

3. Description of Related Art

Current audio file formats commonly used are, among others, AAC, AC-3, ATRAC3plus, MP3, and WMA9. Users can only play such files and cannot interact with them.

Therefore, what is needed is an electronic audio playing apparatus with an interactive function and a method for achieving the interactive function.

### BRIEF DESCRIPTION OF THE DRAWINGS

The components of the drawings are not necessarily drawn to scale, the emphasis instead being placed upon clearly illustrating the principles of the electronic audio playing apparatus. Moreover, in the drawings, like reference numerals designate corresponding parts throughout several views.

FIG. 1 is a block diagram of an electronic audio playing apparatus with an interactive function in accordance with a first exemplary embodiment.

FIG. 2 is a schematic diagram of a first exemplary data structure of an interactive file stored in the electronic audio playing apparatus of FIG. 1.

FIG. 3 is a schematic diagram of a second exemplary data structure of the interactive file.

FIG. 4 is a schematic diagram of an audio question file access method in accordance with an exemplary embodiment.

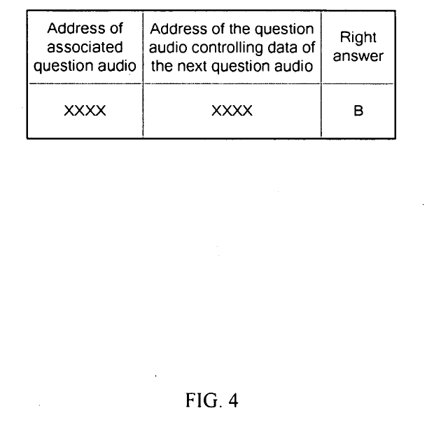

FIG. 5 is a schematic diagram of a right answer feedback audio database in accordance with an exemplary embodiment.

FIG. 6 is a schematic diagram of a wrong answer feedback audio database in accordance with an exemplary embodiment.

FIG. 7 is a flowchart of an interactive method applied on the electronic audio playing apparatus of FIG. 1, in accordance with an exemplary embodiment.

FIG. 8 is a block diagram of an electronic audio playing apparatus with an interactive function in accordance with a second exemplary embodiment.

FIG. 9 is a schematic diagram of an appraising database in accordance with an exemplary embodiment.

FIG. 10 is a flowchart of a method for appraising the response answers from the user after all the question audios are played in accordance with an exemplary embodiment.

### DETAILED DESCRIPTION

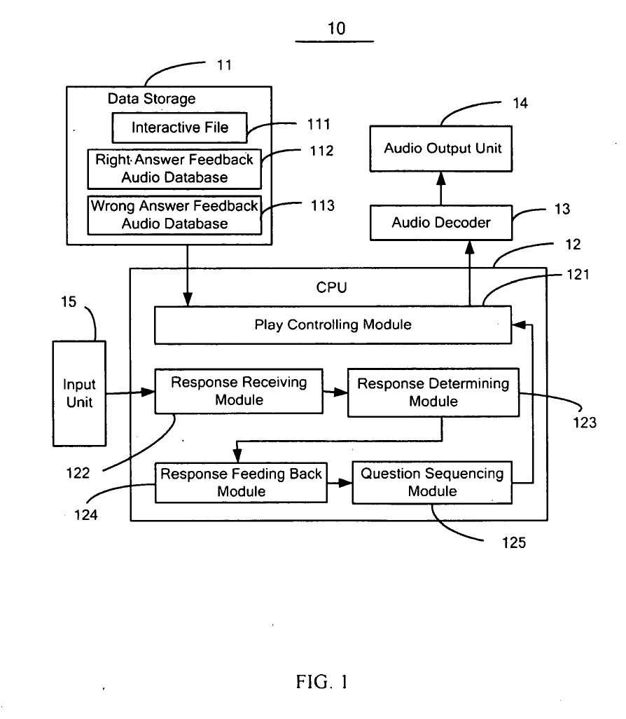

FIG. 1 is a block diagram of an electronic audio playing apparatus with an interactive function (hereafter “the apparatus”) in accordance with a first exemplary embodiment. The apparatus 10 can interact with users. For example, when the apparatus 10 is configured for using in an educational environment it can automatically play audio files that are questions for the user to answer after the user has listened to some study materials. Additionally, there are audio files that can be played after the user answers the questions, that can be used to give the user a feedback on whether the answer by the user is correct or not.

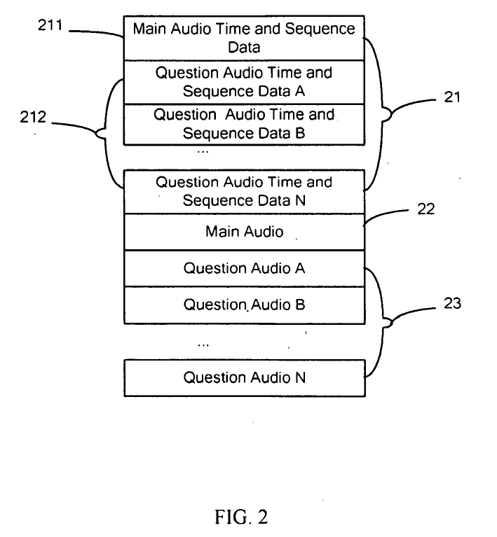

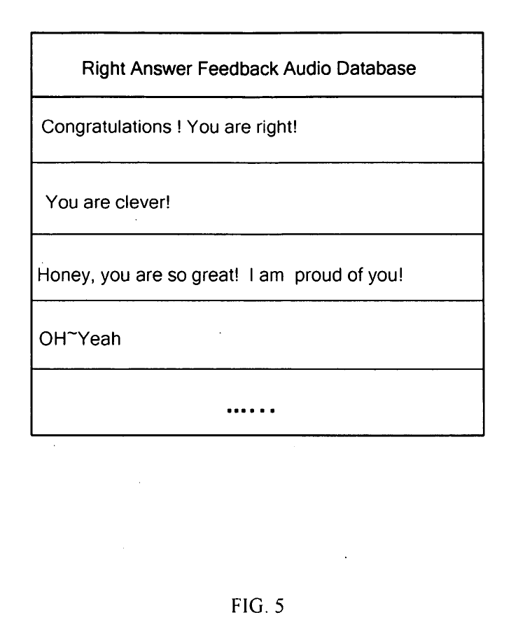

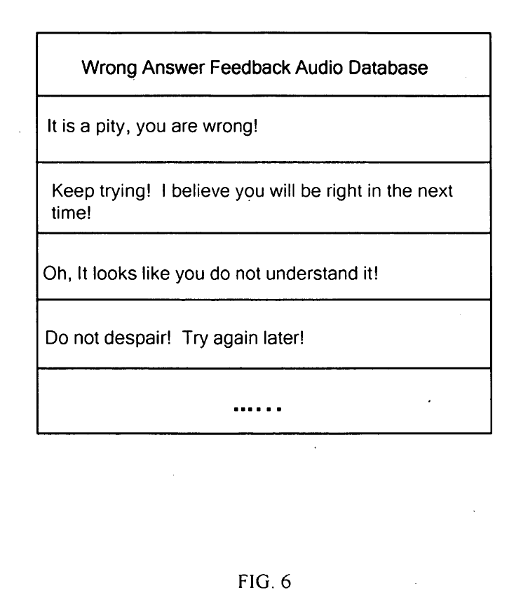

The apparatus 10 includes a data storage 11, a central processing unit (CPU) 12, an audio decoder 13, an audio output unit 14, and an input unit 15. The data storage 11 stores at least one interactive file 11, a right answer feedback audio database 12, and a wrong answer feedback audio database 113. Referring to FIG. 2, each interactive file 111 includes time and sequence data 21, a main audio 22, and at least one question audio 23. Content of the main audio 22 is, for example, a story, a song, an article or other audio content. The at least one question audio 23 is a question regarding content of the main audio 22. The right answer feedback audio database 112 includes at least one feedback audio for expressing that the answer by the user is the right answer, as shown in FIG. 5. The wrong answer feedback audio database 113 includes at least one feedback audio for expressing that the answer by the user is the wrong answer, as shown in FIG. 6

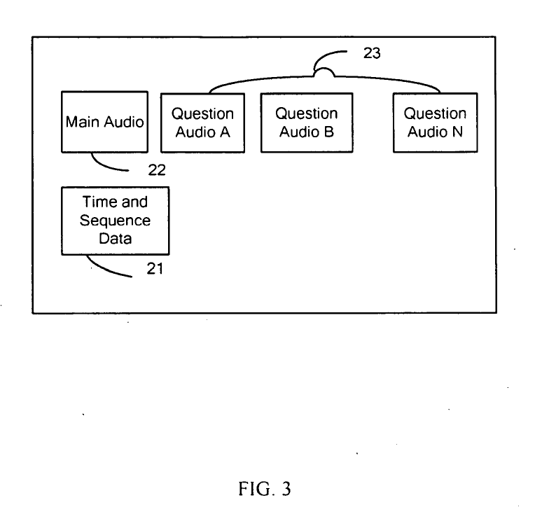

In another embodiment, the time and sequence data 21, the main audio 22, and each of the question audios 23 are stored in the data storage 11 as separate files, as shown in FIG. 3.

The time and sequence data 21 is a kind of metadata that describes the structure of the interactive file 111. The time and sequence data includes a main audio time and sequence data 211 and a plurality of question audio time and sequence data 212. The main audio time and sequence data 211 includes address of the main audio 22.

Each of the question audio time and sequence data 212 is associated with a question audio 23, and includes information related to the associated question audio 23. For example, the question audio time and sequence data 212 records address of the associated question audio 23, the address of the question audio time and sequence data 212 of the next question audio 23, and a right answer of the associated question audio 23.

The CPU 12 includes a play controlling module 121, a response receiving module 122, a response determining module 123, a response feeding back module 124, and a question sequencing module 125.

The play controlling module 121 is for accessing the time and sequence data 21 of the interactive file 111, and further accessing the main audio 22 according to the address recorded in the main audio time and sequence data 211, and accessing the question audios 23 according to the addresses recorded in the question audio time and sequence data 212. After decoding by the decoder 13, the accessed main audio 22 and question audio 23 is output through the audio output unit 14.

The response receiving module 122 is for receiving and recognizing input signals generated by the input unit 15 and thus to determine answers from the user. The input unit 15 can be buttons, touch sensors, or an audio input device such as a microphone. In this exemplary embodiment, the input unit 15 is buttons. Accordingly, the user can input different answers by pressing different buttons. For example, there can be four buttons A-D for inputting answers A-D.

The response determining module 123 is for comparing the answer from the user with the right answer included in the question audio time and sequence data 212 to determine whether the answer from the user is right or wrong.

The response feeding back module 124 obtains one feedback audio from the right answer feedback audio database 112 when the response determining module 123 determines that the answer from the user is right and obtains one feedback audio from the wrong answer feedback audio database 113 when the response determining module 124 determines that the answer from the user is wrong answer. The obtained feedback audio is output through the audio output unit 14 after being decoded by the decoder 13.

The question sequencing module 125 is for determining whether the address of the question audio time and sequence data 212 of the next question audio 23 is a predetermined value after the feedback audio is output. If the address of the question audio time and sequence data 212 of the next question audio 23 is the predetermined value, the question sequencing module 125 ends playing the interactive file 111. If the address of the next question audio time and sequence data 212 is not the predetermined value, the question sequencing module 125 notifies the play controlling module 121 to access the next question audio time and sequence data 212 according to the corresponding address.

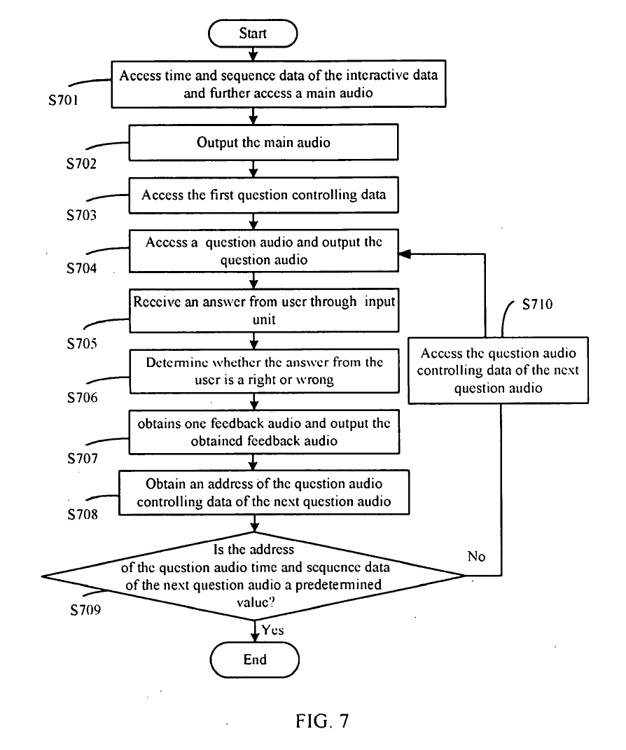

FIG. 7 is a flowchart of an interactive method applied on the electronic audio playing apparatus of FIG. 1, in accordance with an exemplary embodiment. In step S701, the play controlling module 121 accesses the time and sequence data 21 of the interactive file 111, and further accesses the main audio 22 according to the address of the main audio 22 recorded in the main audio time and sequence data 211.

In step S702, after decoded by the decoder 13, the accessed main audio 22 is output through the audio output unit 14.

In step S703, the play controlling module 121 accesses the first question audio time and sequence data 212 from the time and sequence data 21.

In step S704, the play controlling module 121 accesses the question audio 23 according to the address included in the accessed question audio time and sequence data 212, and outputs the accessed question audio 23 through the audio output unit 14 after the accessed question audio 23 is decoded by the decoder 13.

In step S705, the response receiving module 122 receives the response answer from user through the input unit 15.

In step S706, the response determining module 123 compares the response answer from user with the right answer included in the question audio time and sequence data 212 to determine whether the response answer from user is a right or wrong answer.

In step S707, the response feeding back module 124 obtains one feedback audio from the right answer feedback audio database 112 or the wrong answer feedback audio database 113 according to the determining result of step S706. The obtained feedback audio is output through the audio output unit 14 after decoded by the decoder 13.

In step S708, the question sequencing module 125 obtains the address of the question audio time and sequence data 212 of the next question audio 23.

In step S709, the question sequencing module 125 determines whether the address of the next question audio time and sequence data 212 is a predetermined value. If the address of the next question audio time and sequence data 212 is a predetermined value, the question sequencing module 125 ends playing the interactive file 111.

If the address of the next question audio time and sequence data is not a predetermined value, in step S710, the question sequencing module 125 notifies the play controlling module 121 to access the next question audio time and sequence data 212 according to the address of the next question audio time and sequence data 212, and the procedure goes to step S704.

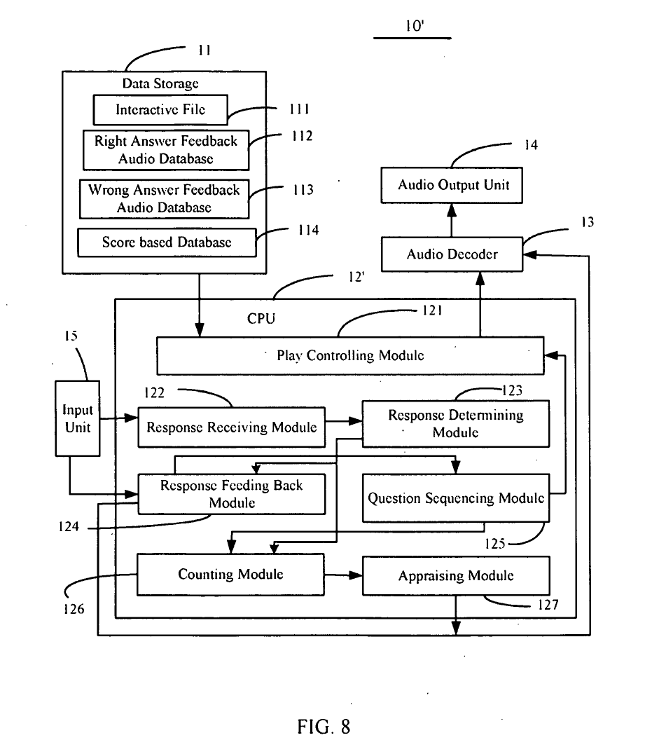

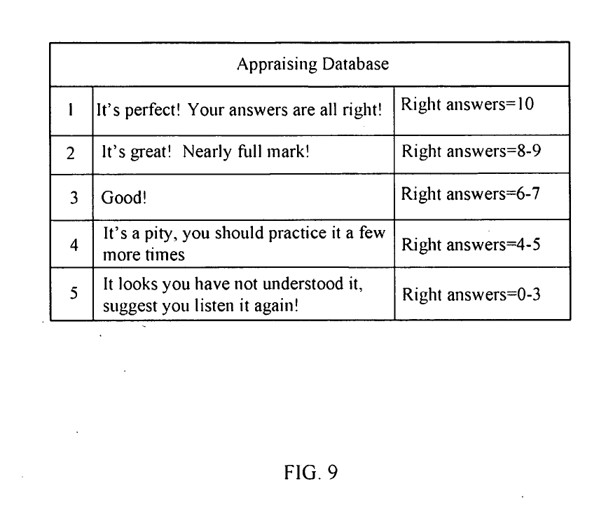

FIG. 8 is another block diagram of the electronic audio playing apparatus in accordance with a second exemplary embodiment. In the second exemplary embodiment, the data storage 11 further stores a user's score and a score based audio database 114. The score is the number of the right answers from the user. The initial value of the score is “0”. In the exemplary embodiment, the score is divided into a plurality of ranges. Each range is associated with a score based audio. The relationship between the ranges of the score and the score based audio is included in the score based audio database 114. For example, as shown in FIG. 9, there are 10 questionaudios, the possible number of right answers is divided into five ranges, such as 10, 8-9, 6-7, 4-5, and 0-3. Each range has an associated score based audio.

The CPU 12′ of the apparatus 10′ further includes a score counting module 126, and an appraising module 127. The counting module 126 is for increasing the score according to the determining result of the response determining module 123. For example, if the response determining module 123 determines that the current answer from the user is right, the counting module 126 adds 1 to the score, if the response determining module 123 determines that the answer from the user is wrong, then the count of the counting module 126 stays the same.

The appraising module 127 is for obtaining the score when the address of the next question audio time and sequence data 212 is a predetermined value, determining the range which the score falls into, and obtaining the associated score based audio from the score based audio database 114. The score based audio is output through the audio output unit 14 after being decoded by the decoder 13.

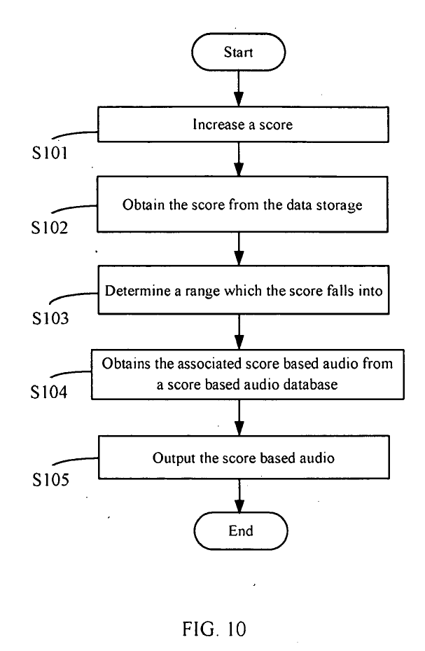

FIG. 10 is a flowchart of a method for appraising answers from the user after all the question audios are played in accordance with an exemplary embodiment. In step S101, the score counting module 126 increases the score according to the determined result of the response determining module 123.

In step S102, the appraising module 127 obtains the score from the data storage 11 when the address of the next question audio time and sequence data 212 is a predetermined value.

In step S103, the appraising module 127 determines the range which the score falls into.

In step S104, the appraising module 127 obtains the associated score based audio of the determined range from the score based audio database 114.

In step S105, the appraising module 127 outputs the score based audio through the audio output unit 14 after being decoded by the decoder 13.

Although the present invention has been specifically described on the basis of preferred embodiments, the invention is not to be construed as being limited thereto. Various changes or modifications may be made to the embodiment without departing from the scope and spirit of the invention.

What is claimed is:

1. An electronic audio playing apparatus with an interactive function, comprising:
a data storage for storing at least one interactive file, a right answer feedback audio database, and a wrong answer feedback audio database, wherein the interactive file comprises time and sequence data, a main audio, and at least one question audio, the time and sequence data include a main audio time and sequence data and a plurality of question audio time and sequence data each of which is associated with one of the at least one question audio, the question audio time and sequence data comprises address of associated question audio, address of question audio time and sequence data of the next question audio, and a right answer of the associated question audio, the right answer feedback audio database and the wrong answer feedback audio database respectively comprises at least one feedback audio;
a play controlling module for accessing the time and sequence data of the interactive file, and further accessing the main audio according to the address of the main audio comprised in the main audio time and sequence data, and accessing the question audio according to the address of the question audio comprised in the question audio time and sequence data, outputting the accessed main audio and question audio through an audio output unit;
a response receiving module for receiving and recognizing input signals generated by an input unit and thus to determine answers from a user;
a response determining module for comparing the answer from the user with the right answer stored in the question audio time and sequence data to determine whether the answer from the user is right or wrong;
a response feeding back module for obtaining one feedback audio from the right answer feedback audio database or the wrong answer feedback audio database according to the determining result of the response determined module;
a question sequencing module for accessing the address of question audio time and sequence data of the next question audio from the question audio time and sequence data of the question audio currently played, and notify the play controlling module to access the next question audio according to the address of the question audio time and sequence data of the next question audio.

2. The apparatus as described in claim 1, wherein the time and sequence data, the main audio, and a plurality of question audios are stored in the data storage as separate files, which are the at least one interactive file.

3. The apparatus as described in claim 1, wherein the data storage further stores a score and a score based audio database, the score is the number of the right answers from the user, the score is divided into a plurality of ranges, the score based audio database includes relationship between the ranges of the score and score based audios associated with each range, the apparatus further comprises a score counting module and an appraising module, the counting module is for increasing the score according to the determining result of the response determining module, the appraising module is for obtaining the score when the address of the next question audio time and sequence data is a predetermined value, determining the range which the score falls into, and obtaining the associated score based audio from the score based audio database.

4. An interactive method applied on an electronic audio playing apparatus, comprising:
(a) providing a data storage for storing at least one interactive file, a right answer feedback audio database, and a wrong answer feedback audio database, wherein the interactive file comprises time and sequence data, a main audio, and at least one question audio, the time and sequence data includes a main audio time and sequence data and a plurality of question audio time and sequence data each of which is associated with one question audio, the question audio time and sequence data comprises address of associate question audio, address of question audio time and sequence data of the next question audio, and a right answer of the associated question audio, the right answer feedback audio database and the wrong answer feedback audio database respectively comprises at least one feedback audio;
(b) accessing time and sequence data of the interactive file;
(c) accessing the main audio according to the address of the main audio which comprised in the main audio time and sequence data and outputting the accessed main audio through an audio output unit;
(d) accessing the first question audio time and sequence data from the time and sequence data;
(e) accessing the question audio according to the address of the question audio which is stored in the question audio time and sequence data and outputting the accessed question audio through the audio output unit;
(f) receiving and recognizing input signals generated by an input unit and thus to determine answers from user;
(g) comparing the answer from the user with the right answer stored in the question audio time and sequence data to determine whether the answer from the user is right or wrong;
(h) obtaining one feedback audio from the right answer feedback audio database or the wrong answer feedback audio database according to the determined result of step (g);
(i) accessing the address of question audio time and sequence data of the next question audio from the question audio time and sequence data of the question audio currently played, then goes to step (d).

5. The interactive method as described in claim 4, wherein the time and sequence data, the main audio, and a plurality of question audios are stored in the data storage as separate files, which are the at least one interactive file.

6. The interactive method as described in claim 4, wherein the data storage further stores a score and a score based audio database, the score is the number of the right answers from the user, the score is divided into a plurality ranges, the score based audio database includes relationship between the ranges of the score and score based audios associated with each range, the method further comprises:
increasing the score according to step (g);
obtaining the score when the address of the next question audio time and sequence data is a predetermined value;
determining the range which the score falls into;
obtaining the associated score based audio from the score based audio database.
